(19) United States
(12) Patent Application Publication
(10) Pub. No.: US 2004/0098343 A1
(43) Pub. Date: May 20, 2004

(54) Contents reproducing apparatus, contents reproduction control program and recording medium having a contents reproduction control program recorded thereon

(75) Inventor: Motokazu Kawaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI, Tokyo (JP)

(21) Appl. No.: 10/695,998

(22) Filed: Oct. 30, 2003

(30) Foreign Application Priority Data
Nov. 18, 2002 (JP) 2002-333546

(51) Int. Cl. G06F 17/60

(52) U.S. Cl. 705/51

(57) ABSTRACT

A contents reproducing apparatus for acquiring encrypted data, reproducing image data from contents data restored from the encrypted data and displaying the image data on a browser screen of a browser comprises: decryption means for decrypting the encrypted data; memory means for temporarily storing contents data restored by the decryption means and use restriction information of the restored contents data; display process means for displaying the image data reproduced from the contents data stored in the memory means on the browser screen; and contents reproduction control means for generating a browser assisting function in accordance with the use restriction information of the contents data, while inhibiting usage of a contents using function of the browser, and executing the contents using function inhibited by the browser assisting function.

### BACKGROUND OF THE INVENTION

1. Field of the Invention

The present invention relates to a contents reproducing apparatus and a contents reproduction control program that restrict the usages (printing, saving, etc.) of digital contents (characters, images, moving pictures, etc.) which are displayed on the browser screen of a browser and are to be circulated or distributed over electric communication lines, such as the Internet or an intranet, or via a recording medium such as CD-ROM, at the time of displaying the digital contents on the browser screen so as to prevent illegitimate use of the digital contents by a user or information leak to a third party, and also relates to a recording medium on which such a contents reproduction control program is recorded.

2. Description of the Related Art

Recently, Internet users are increasing drastically and the Internet is becoming indispensable as the infrastructure in information distribution or for providing services. For instance, computer programs, which have been distributed so far in the tangible form such as CD-ROMs, books and the like, and also so-called information resources such as books are now distributed on a network which is connected to personal computers, portable telephones or the like, and further various services such as provision of on-line games and an electronic bulletin board are also appearing nowadays.

Such prevalence of the Internet increases the risk that information distributed over a network may be altered or illegitimately used, and in order to familiarize and promote the distribution of programs, image contents, etc. hereafter, it is essential to provide some measures to prevent illegitimate use and alteration of information, which is distributed over a network and is to be displayed on personal computers or the like.

For example, there is a technique called digital rights management (hereinafter simply called “DRM”) as a technique for evading such illegitimate use. This DRM technique encrypts copyright information specifying what kinds of usage are permitted and contents before the transmission thereof, and allows only those users who match with the conditions to decrypt the encrypted contents and view the contents. Depending on the encrypted conditions, it is possible to arbitrarily set the number of times the contents can be reproduced, the period during which the contents can be viewed, whether or not the contents can be saved on a CD, DVD and so on.

Image contents, e.g., Web pages, which have been received by a terminal unit such as a personal computer are generally displayed by use of a browser. This Web browser is an application program which requests Web contents specified by a Uniform Resource Locator (hereinafter called “URL”) and displays the Web contents, and designates an URL within a request of a hypertext transfer protocol (hereinafter called “HTML”). This request is transferred to a Web server system which supports information and contents specified by the URL and the Web server system sends the corresponding contents to the terminal unit that has made the request.

The above-described prior art is disclosed in, for example, Japanese Patent Application Laid-Open No. 2002-229447 (page 4, left column line 29 to right column line 5).

As a conventional application program such as a Web browser is designed with disclosure of characters, image contents, etc. in mind, the content that has been displayed on the browser screen of a personal computer or the like is constructed in such a way that it can be saved easily by a Web site user by means of the print function, file saving function and so forth of the browser. Even in a case where the application program, if designed in such a way as to distribute encrypted digital contents, merely decrypts encrypted data and does not take into consideration the restriction of the use of digital contents after being displayed, there arises such a problem that the displayed digital contents can be used illegitimately by a user and be readily leaked.

As a solution to the above-mentioned shortcomings, a function to permit viewing only and prohibit printing, file saving and so forth may be added as a browser function. This however requires that a novel Web browser having such a function should be created. In addition, in case of using available Web browsers open to the public, the Web browsers cannot be provided with such a function without permission.

In case of using the DRM technique, an exclusive server system called a copyright information management server should be provided in addition to the server system that distributes contents. In this case, while conditions corresponding to multifarious business models, such as viewing of contents per payment of charge, can be set, there is a system problem that such a special server system should be provided.

### SUMMARY OF THE INVENTION

The present invention has been made to solve the aforementioned problems and aims at providing a novel contents reproducing apparatus and a novel contents reproduction control program that can prohibit illegitimate use of digital contents displayed on the browser screen of a browser open to the public and leakage of such digital contents to a third party, while using the browser, and a recording medium on which such a contents reproduction control program is recorded.

A contents reproducing apparatus according to the present invention acquires encrypted data, reproduces image data from contents data restored from the encrypted data and displays the image data on a browser screen of a browser. The contents reproducing apparatus comprises decryption means for decrypting the encrypted data; memory means for temporarily storing the contents data restored by the decryption means and use restriction information of the restored contents data; display process means for displaying the image data reproduced from the contents data stored in the memory means on the browser screen; and contents reproduction control means for generating a browser assisting function according to the use restriction information of the contents data while inhibiting the usage of a contents using function of the browser, and executing the contents using function inhibited by the browser assisting function.

The above-described structure of the invention can allow a specific user who has an allowable identification (ID) information to carry out printing and saving of Web contents displayed on a browser screen and image copying based on use restriction information, and can reliably inhibit illegitimate use of the Web contents by a third party. Each user cannot use other than a browser assisting function permitted by that use restriction information which matches with the ID information, thus preventing illegitimate usage of contents by a user who is permitted to use the contents. It is therefore possible to surely prevent leakage of the Web contents displayed on the browser screen. This can ensure to achieve simple prohibition of information leakage without providing a special server system. This invention can be adapted to both digital contents which are distributed on-line and digital contents which are distributed off-line.

### BRIEF DESCRIPTION OF THE DRAWINGS

FIG. 1 is a schematic diagram of a system configuration which realizes a contents reproducing method according to a first embodiment of the present invention;

FIG. 2 is a functional block diagram illustrating the specific structures of a contents reproducing apparatus, etc. shown in FIG. 1;

FIG. 3 is a structural diagram showing the data structure of encrypted data which is distributed to the contents reproducing apparatus 3;

FIG. 4 is a flowchart for explaining a sequence of processes of the contents reproducing apparatus 3 shown in FIG. 1;

FIG. 5 is a flowchart for explaining a use restriction process of the contents reproducing apparatus 3 shown in FIG. 1;

FIG. 6 is a display screen showing an interface screen, etc. for a contents reproduction control program 9 which is generated on the browser screen of a display section 8;

FIG. 7 is a schematic diagram of a system configuration which realizes a contents reproducing method according to a second embodiment of the invention; and

FIG. 8 is a functional block diagram illustrating the specific structures of a contents reproducing apparatus, etc. shown in FIG. 7.

### DETAILED DESCRIPTION OF THE PREFERRED EMBODIMENTS

(First Embodiment)

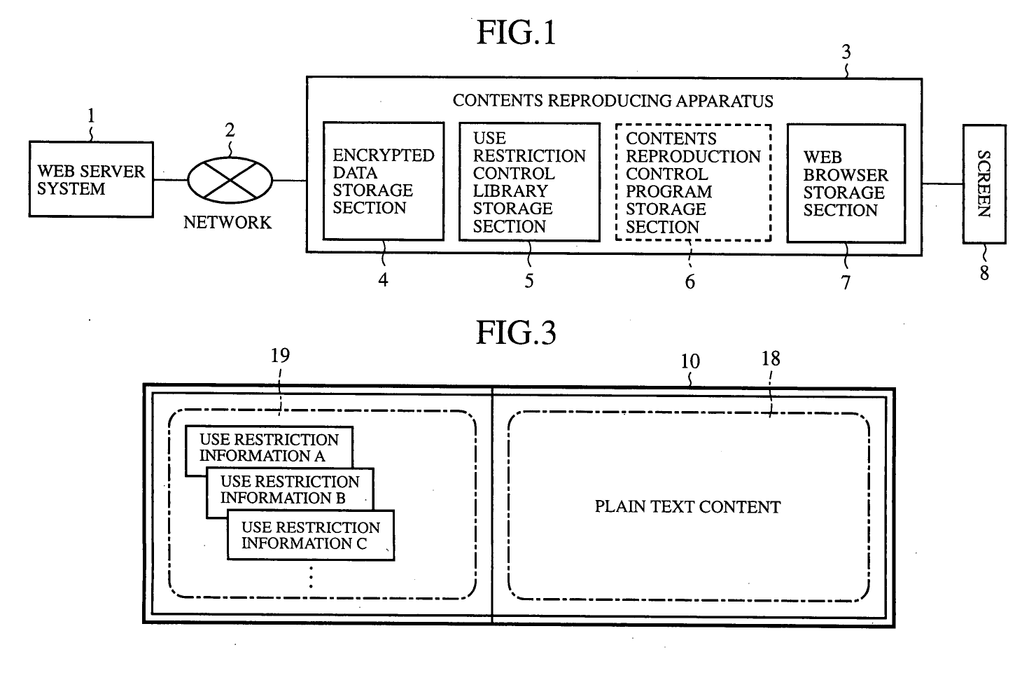

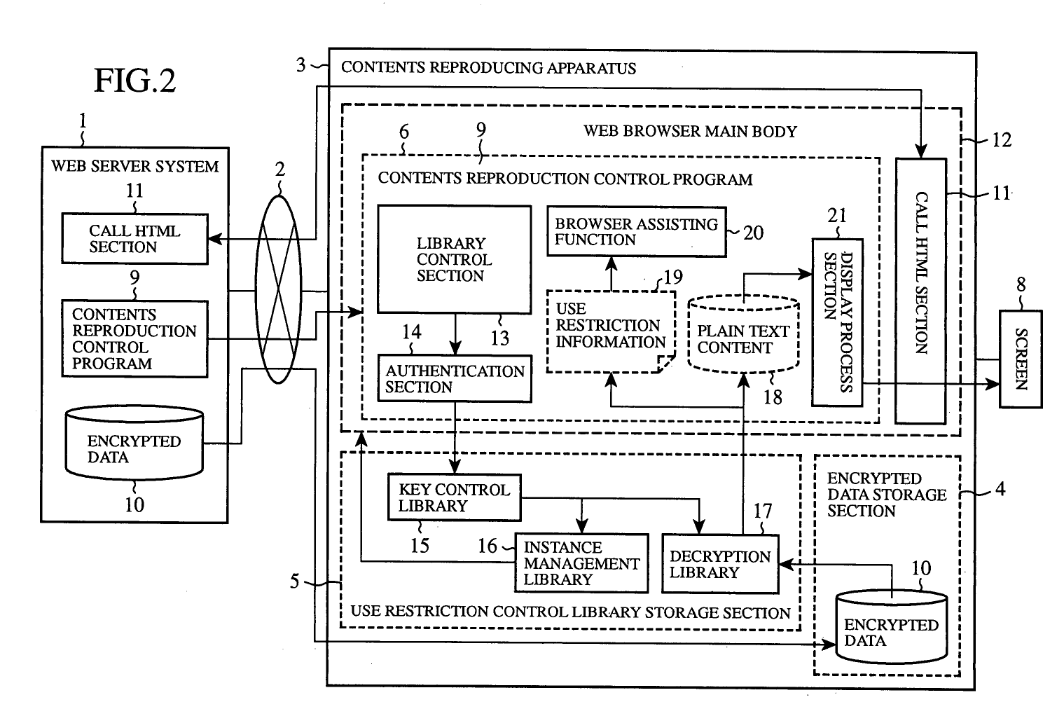

The first embodiment of the invention will be described below with reference to FIGS. 1 to 6. FIG. 1 is a schematic diagram of a system configuration which realizes a contents reproducing method according to the first embodiment, and FIG. 2 is a functional block diagram illustrating the specific structures of a contents reproducing apparatus, etc. In FIGS. 1 and 2, reference numeral “1” denotes a Web server system (hereinafter called “server system”) which saves contents data of Web contents, reference numeral “2” denotes an electric communication line, such as the Internet or intranet, (hereinafter called “network”), and reference numeral “3” denotes a contents reproducing apparatus, such as a personal computer or a portable information terminal, (i.e., a Personal Data Assistant—PDA), connected to the server system 1 over the network 2. The contents reproducing apparatus 3 displays image data reproduced from the contents data, in other words, Web contents, on a browser screen generated on a display section 8.

Saved in the server system 1 are contents data of the Web contents encrypted by use of a predetermined encryption system and use restriction information of the contents data. The contents data will be hereinafter called “encrypted data”. Individual Web contents which are to be reviewed by the contents reproducing apparatus (hereinafter called “terminal unit”) 3 according to the first embodiment are distributed (downloaded) to the terminal unit 3 from the server system 1 over the network 2. The types of Web contents include a so-called HTML file, various kinds of image files (such as the BMP type, GIF type, JPEG type and PNG type) and a PDF file, to each of which use restriction information corresponding to each content is affixed.

The terminal unit 3 is provided with an encrypted data storage section 4 which stores encrypted data downloaded from the server system 1, a use restriction control library storage section 5 which stores a use restriction control program, a contents reproduction control program storage section 6 which stores a contents reproduction control program, a Web browser storage section 7 which stores a Web browser program and the display section 8 which generates a browser screen for displaying Web contents reproduced from the contents data restored through a decryption process. Encrypted data distributed from the server system 1 is stored in the encrypted data storage section 4 via an interface section (not shown), provided in the terminal unit 3, with the network 2.

In the contents reproducing apparatus according to the first embodiment, the contents reproduction control program is also saved in the server system 1 and is distributed to the terminal unit 3 over the network 2 from the server system 1 in accordance with a transfer request from the terminal unit 3. The contents reproduction control program distributed to the terminal unit 3 is stored in the contents reproduction control program storage section 6 via the interface section.

While the encrypted data storage section 4, the use restriction control library storage section 5 and the Web browser storage section 7 are provided on a physical recording medium, such as a hard disk, in the terminal unit 3, the contents reproduction control program storage section 6 is provided in an electronic part which temporarily stores data in the terminal unit 3, e.g., a memory, such as RAM (Random Access Memory). That is, the contents reproduction control program according to the present invention is stored in a memory, such as RAM, so as to be dynamically generated on such a memory.

In FIG. 2, a contents reproduction control program 9 and encrypted data 10 are the contents reproduction control program and the decrypted data, respectively, which are saved in the server system 1 and to be downloaded to the terminal unit 3. Reference numeral “11” denotes a call HTML section, which is activated to download the contents reproduction control program 9 from the server system 1. When the Web browser stored in the Web browser storage section 7 is activated and a browser screen is generated on the display section 8, the call HTML section 11 is displayed on the browser screen. The user of the terminal unit 3 can make a transfer request for the contents reproduction control program 9 with respect to the server system 1 by accessing the call HTML section 11 thus displayed on the browser screen.

Reference numeral 12 denotes a Web browser program (hereinafter called “Web browser”), which is activated in the Web browser storage section 7 to perform decryption, display and other processes on the general Web contents written in the HTML. Reference numeral 13 and 14 denote a library control section and an authentication section, respectively, which constitute the contents reproduction control program 9 that is activated in the contents reproduction control program storage section 6. The library control section 13 controls the activation of the authentication section 14 and a key control library 15 constituting a use restriction control library that is activated in the use restriction control library storage section 5. The authentication section 14 performs a process of generating an authentication screen on the browser screen of the display section 8, prompting the input of ID information, for example, user ID and a password, and requests the user of the terminal unit 3 to input the ID information. When the ID information input on the authentication screen matches with prestored ID information, the authentication section 14 informs the key control library 15 of authentication information indicating that event and displays on the browser screen a message informing the user who has input the ID information that the contents reproduction control program 9 is available.

The key control library 15, an instance management library 16 and a decryption library 17 constitute the use restriction control library that is activated in the use restriction control library storage section 5. The key control library 15 executes a process of restricting the use of the contents using function of the Web browser 12 based on the authentication information from the authentication section 14 and the use restriction information of the contents data restored by the decryption process. The instance management library 16, which is activated by an instruction from the key control library 15, checks the activation state of the Web browser 12. The decryption library 17 decrypts the encrypted data 10 stored in the encrypted data storage section 4 to restore the original contents data and its use restriction information.

Reference numeral 18 denotes data of a plain text content (hereinafter called “plain text content”), which is restored through the decryption process by the decryption library 17 and is temporarily stored in the contents reproduction control program storage section 6. Reference numeral “19” denotes the use restriction information of the plain text content 18, which is likewise restored through the decryption process by the decryption library 17 and is temporarily stored in the contents reproduction control program storage section 6. Reference numeral 20 denotes a browser assisting function program (hereinafter called “browser assisting function”) that generates on the browser screen of the display section 8 a browser assisting function equivalent to the contents using function of the Web browser 12 which has become unavailable under the control of the contents reproduction control program 9 and prompts the users to operate the function. Reference numeral 21 denotes a display process section that performs a process of reproducing image data from the plain text content 18 and displaying the image data on the browser screen of the display section 8.

FIG. 3 is a structural diagram showing the data structure of the encrypted data which is distributed to the terminal unit 3. FIG. 3 shows the plain text content 18 and its use restriction information 19 both encrypted by a predetermined encryption system. As shown in FIG. 3, the encrypted data 10 is generated by integrating the plain text content 18 and its use restriction information 19 encrypted by the predetermined encryption system. Restoring the use restriction information 19 together with the plain text content 18 prevents unauthorized use and leakage of the information to a third party. Mutually different encryption systems can be used for the plain text content 18 and the use restriction information 19. For instance, while the plain text content 18 can be encrypted using a key A, the use restriction information 19 can be encrypted using another key B. The use of different encryption systems can reliably inhibit leakage, alteration and so forth of information over the network 2 until the information is distributed to the terminal unit 3.

As shown in FIG. 3, the use restriction information 19 can be registered for each user. For example, use restriction information A which permits only printing of the Web contents displayed on the Web browser 12 based on the plain text content 18 can be registered for a user A, and use restriction information B which permits printing and file saving of the Web contents displayed on the Web browser 12 based on the plain text content 18 can be registered for a user B. As plural pieces of use restriction information (A, B, C, so forth) can be registered with respect to a single plain text content 18, the common encrypted data 10 can be used by multiple users.

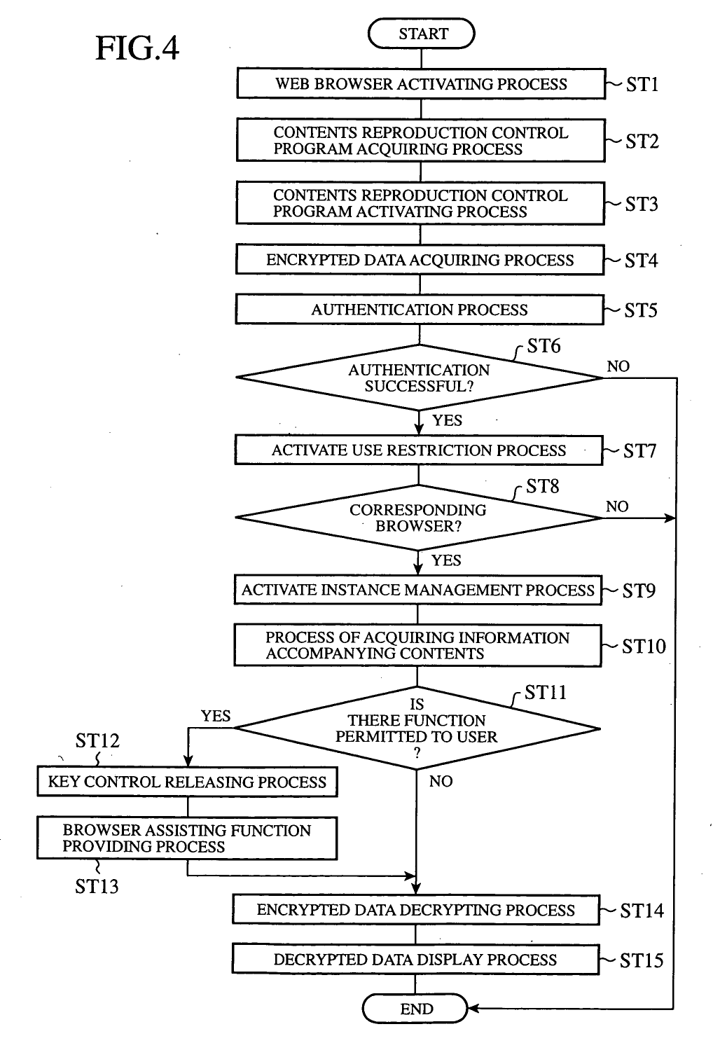

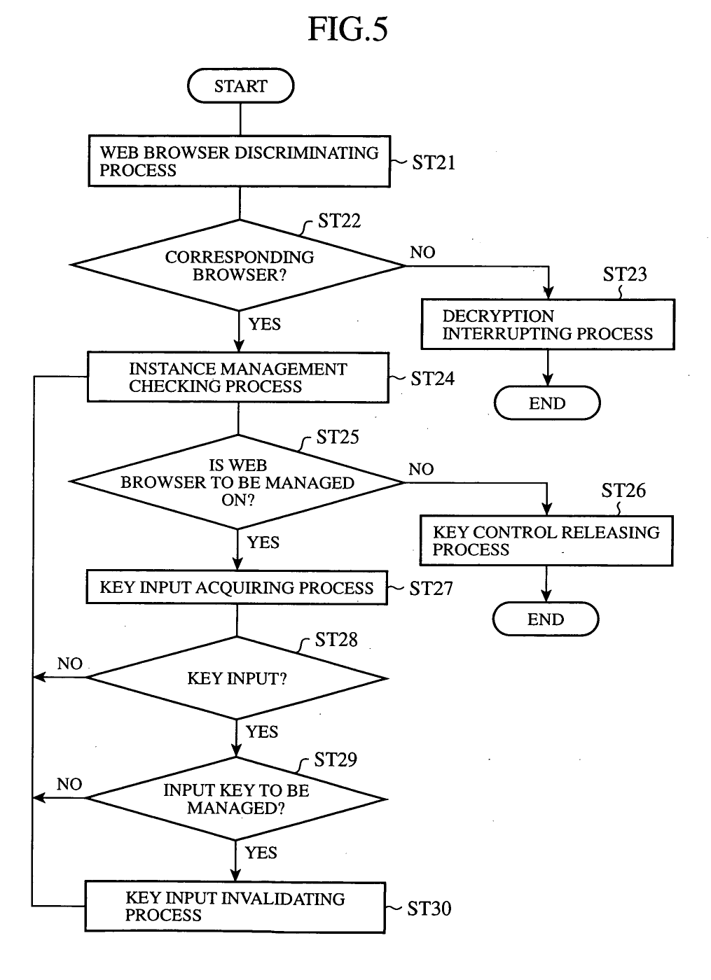

Next, the operation will be explained referring to FIGS. 4 and 5. FIG. 4 is a flowchart for explaining the sequence of processes of the terminal unit 3 shown in FIG. 1, and FIG. 5 is a flowchart for explaining the use restriction process of the terminal unit 3 shown in FIG. 1. In a case where the user of the terminal unit 3 acquires encrypted data 10 saved in the server system 1 and views the Web contents in the encrypted data 10, the user first activates a predetermined Web browser 12 via input means, such as a mouse or a keyboard (ST1).

When the Web browser 12 is activated, the browser screen of the Web browser 12 is generated on the display section 8 and the call HTML section 11 is generated on the browser screen. The user accesses a call HTML displayed on the call HTML section 11 to make a transfer request for the contents reproduction control program 9 with respect to the server system 1 (ST2). When the transfer request for the contents reproduction control program 9 is made by the call HTML section 11, the server system 1 distributes (downloads) the contents reproduction control program 9 to the terminal unit that has made the transfer request, or the terminal unit 3 in this case. The contents reproduction control program 9 is stored in the contents reproduction control program storage section 6 via the interface section provided in the terminal unit 3 over the network 2 (ST2).

As the contents reproduction control program 9 downloaded from the server system 1 is stored in the contents reproduction control program storage section 6, the contents reproduction control program 9 is activated and initiates a contents reproduction control process (ST3).

When the contents reproduction control program 9 is activated, the encrypted data 10 saved in the server system 1 is downloaded over the network 2 and is stored in the encrypted data storage section 4 in the terminal unit 3 (ST4).

When the encrypted data 10 is saved in the encrypted data storage section 4, the library control section 13 in the contents reproduction control program 9 is activated to invoke an authentication process to be carried out by the authentication section 14 (ST5).

The authentication section 14 generates on the browser screen of the Web browser 12 a dialog box for authentication, i.e., an authentication screen for inputting ID information such as a user ID and a password (hereinafter called “ID information”) and prompts the user to input the ID information. When the ID information input by the user does not match with prestored ID information, the authentication section 14 decides that the encrypted data 10 saved in the encrypted data storage section 4 is not encrypted data viewable by the user and terminates the process without executing the subsequent process. When the ID information (user ID and password) input by the user matches with the prestored ID information, on the other hand, the authentication section 14 decides that authentication is successful (ST6).

When the authentication section 14 decides that the ID information input by the user matches with the prestored ID information, the library control section 13 activates the key control library 15 in the use restriction control library storage section 5 to execute a browser function restricting process and informs the key control library 15 of the authentication information of the authentication section 14 (ST7).

The key control library 15 determines whether or not the type and version of the Web browser 12 are allowed by the contents reproduction control program 9, and if it found out that the Web browser is not an allowed one, the key control library 15 terminates the process without executing the subsequent process (ST8). In a case where the key control library 15 identifies that the Web browser 12 is a permitted browser, the instance management library 16 is activated to execute a process of monitoring if the activation of the Web browser 12 continues (ST9).

While the browser function restriction process is in progress, the key control library 15 activates the decryption library 17 in the use restriction control library storage section 5 to execute decryption of the encrypted data 10 saved in the encrypted data storage section 4. The encryption process by the decryption library 17 restores the plain text content 18 and the corresponding use restriction information 19 from the encrypted data 10 saved in the encrypted data storage section 4. In this example, the encrypted data 10 includes plural pieces of use restriction information set for each user, and use restriction information having the ID information that matches with the ID information which has been decided as having successfully authenticated by the authentication section 14, e.g., the use restriction information A in case of the user A, is restored by the decryption library 17. The restored plain text content 18 and use restriction information A are saved in the contents reproduction control program storage section 6 (ST10).

The key control library 15 determines from the restored use restriction information A whether or not the Web browser 12 has any allowed contents using function for the user (ST11). If there is an allowed contents using function, the key control library 15 performs a process of releasing the monitoring of a key input to be carried out for the execution of that function (ST12). Meanwhile, the contents reproduction control program 9 determines from a use restriction rule registered in the use restriction information 19 whether or not there is an allowed contents using function for the user, and generates such an allowed function, if any, as the browser assisting function 20 on the browser screen of the display section 8 (ST13). By using the browser assisting function 20 displayed on the browser screen, each user can use the Web contents displayed on the browser screen and performs an operation on that Web contents, such as printing or saving.

The plain text content 18 and use restriction information which matches with the ID information of the user, e.g., the use restriction information A, are restored from the encrypted data 10 through the decryption process performed by the decryption library 17 (ST14), and the display process section 21 reproduces image data or the Web contents based on the restored plain text content 18 and displays the Web contents on the browser screen of the display section 8 (S15).

As the plain text content 18 and the use restriction information 19 are both managed only on the contents reproduction control program storage section 6, i.e., the memory, such as RAM, provided in the terminal unit 3, at this time, the plain text content 18 and the use restriction information 19 do not remain in the hard disk or cache in the terminal unit 3. This can ensure prevention of information leakage and guarantee the security of the contents displayed on the browser screen.

As the encrypted data 10 to be downloaded from the server system 1 includes the plain text content 18 for reproducing the Web contents and the use restriction information 19 which describes the use restriction rule at the time of viewing the Web contents reproduced from the plain text content 18, each user can use the plain text content 18 in accordance with the use restriction rule described in the use restriction information 19 that matches with the ID information (user ID, password, etc.). In other words, as the system is constructed in such a way that the Web-content distribution side saves the encrypted data 10 comprised of plural pieces of use restriction information 19 corresponding (or appropriate) to the individual users and the plain text content 18 in the server system 1 and each user can use the plain text content 18 in accordance with the use restriction rule described in the use restriction information 19 that matches with the ID information of the user, it is possible to allow only a specific user to view or use Web contents based on the plain text content 18 without providing a special server system or the like.

If the use restriction rule to permit only the print function of the Web browser 12 is registered in the use restriction information A corresponding to the user A, for example, the browser assisting function 20 prompting the use of the print function of the Web browser 12 is generated on the browser screen of the display section 8 so that the user A can print the plain text content 18 generated on the browser screen by using the print function. If the use restriction rule to permit the print function and the screen copy function of the Web browser 12 is registered in the use restriction information B corresponding to the user B, the browser assisting function 20 prompting the use of the print function and the screen copy function of the Web browser 12 is displayed on the browser screen of the display section 8 so that the user B can print the plain text content 18 displayed on the browser screen and do image copying by using the print function and the screen copy function.

It is to be noted that the use restriction rules to be registered in the use restriction information 19 include print permission to permit printing of image data displayed on the browser screen, save permission to permit data saving and screen copy permission to permit screen copying. The number of times the operation of printing, saving or the like is permitted, the number of times the image data can be reproduced and viewed, the period for viewing and so forth can also be registered as use restriction rules.

The use restriction process of the contents reproducing apparatus 3 will be elaborated below referring to FIG. 5. The use restriction process is a process of discriminating the Web browser 12 and monitoring the activation state of the Web browser 12 and further allowing a user to use the contents using function of the Web browser 12, which has been inhibited by the activation of the contents reproduction control program 9, based on the use restriction information 19 included in the encrypted data 10. The type and version of the activated Web browser 12 are discriminated by the key control library 15 (ST21). When the key control library 15 decides that the Web browser 12 is not allowed by the contents reproduction control program 9, the key control library 15 instructs the contents reproduction control program 9 to interrupt the decryption process and terminates the process without executing the subsequent encryption-related process (ST22, ST23).

The instance management library 16 activated by the key control library 15 monitors the activation state of the Web browser 12 (ST24). When the instance management library 16 decides that the activation of the Web browser 12 is ended, the instance management library 16 instructs the key control library 15 to terminate the subsequent process and the key control library 15 releases the key control for the Web browser 12 whose usage has been inhibited by the activation of the contents reproduction control program 9 (ST25, ST26).

When the instance management library 16 decides that the Web browser 12 is activated, the key control library 15 continues the browser function restriction process and handles an event from the input means (not shown) such as the keyboard connected to the terminal unit 3 (ST27). Specifically, when a key input for execution of printing, screen copy or the like has been made through the input means (ST28), the key control library 15 determines, in consideration of the use restriction information 19 set for each user, whether or not the key input is a management target or is an operation which is not permitted (ST29). When it is determined that the key input is a management target, the key control library 15 nullifies the key input (ST30).

The above-described processing continues until the activation of the Web browser 12 is ended, and the use of a key input made through the input means during that period is restricted based on the use restriction information 19 read from the encrypted data 10.

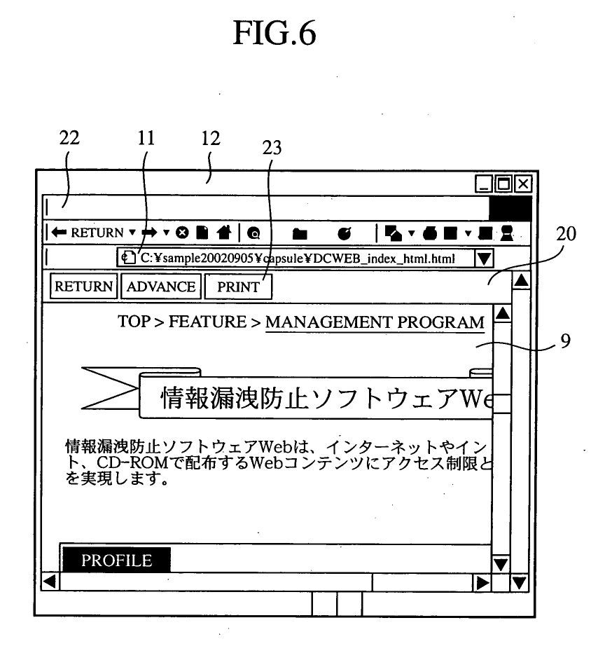

FIG. 6 is a display screen showing an interface screen, etc. for the contents reproduction control program 9 which is generated on the browser screen of the display section 8 as the contents reproduction control program 9 is activated. In FIG. 6, reference numeral “22” denotes the display menu (contents using function) of the Web browser 12 that has been invalidated by the contents reproduction control program 9, and reference numeral “23” denotes the print function which is generated in the browser assisting function 20. Normally, the printing, saving or the like of the Web content displayed on the browser screen is possible by manipulation of the display menu 22 of the Web browser 12. Because the manipulation of the invalidated display menu 22 by using the mouse or keyboard is not allowed at all by the invalidation process of the key control library 15, however, the user of the terminal unit 3 cannot perform an operation, such as printing or saving, through the invalidated display menu 22. As the browser assisting function 20 is generated on the browser screen based on the use restriction information 19 restored from the encrypted data 10, however, the user who has the matched ID information can perform printing, saving, image copying or the like of the Web contents displayed on the browser screen by manipulating the allowed function, e.g., the print function 23, via the browser assisting function 20.

In the terminal unit 3 according to the first embodiment, as described above, while the contents using function of the Web browser 12 which displays Web contents is inhibited by the contents reproduction control program 9, the browser assisting function 20 in place of the contents using function is generated to allow only a specific user to use the Web contents displayed on the browser screen. This can reliably prohibit illegitimate use of Web contents by a third party. As the browser assisting function 20 is generated according to the use restriction information 19 that is registered for each user, each user is allowed to use only the browser assisting function 20 that is permitted by the use restriction information 19 that matches with the ID information of that user. This feature can prohibit also an illegitimate use of a user who is permitted to use Web contents and can thereby surely prevent leakage of the Web contents displayed on the browser screen.

Further, the plain text content 18 and use restriction information 19, which have been restored through the decryption process performed by the decryption library 17 are both managed in the contents reproduction control program storage section 6, i.e., on a memory such as RAM provided in the terminal unit 3. After the displaying of the Web contents, therefore, those plain text content 18 and use restriction information 19 do not remain in the hard disk or cache in the terminal unit 3. Leakage of Web contents can thereby be surely prevented in this point too.

As the contents reproduction control program 9 does not depend on a machine which is activated in association with a Web browser and can be executed on the Web browser 12, the contents reproduction control program 9 can be used in association with various Web browsers which are open to the public. This makes it unnecessary to create a novel browser different from the Web browsers open to the public.

Although the foregoing description has been given of the case where a user ID and a password of which a user has been informed in advance are used in the authentication of the user, a common key which is distributed separately may be used together. The use of such a common key together with the user ID and password makes it impossible for a user to make the above-described content view, even if the user ID and password are leaked, unless the common key should have a match, and can more severely specify a user of the contents to be distributed from the server system 1.

(Second Embodiment)

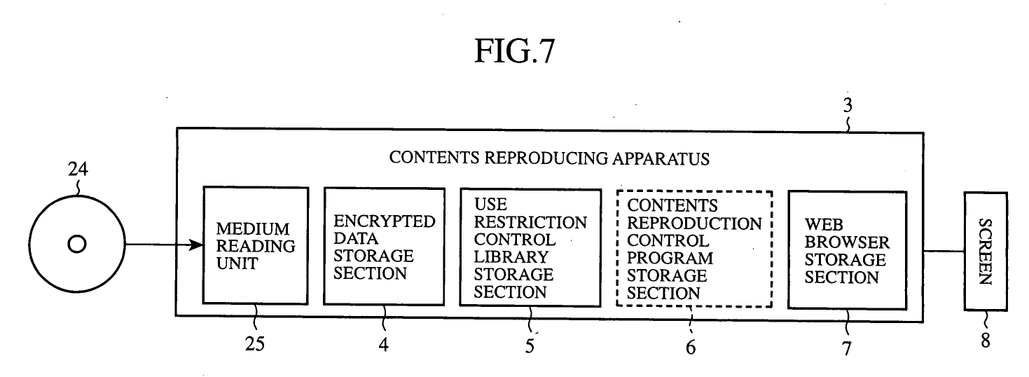

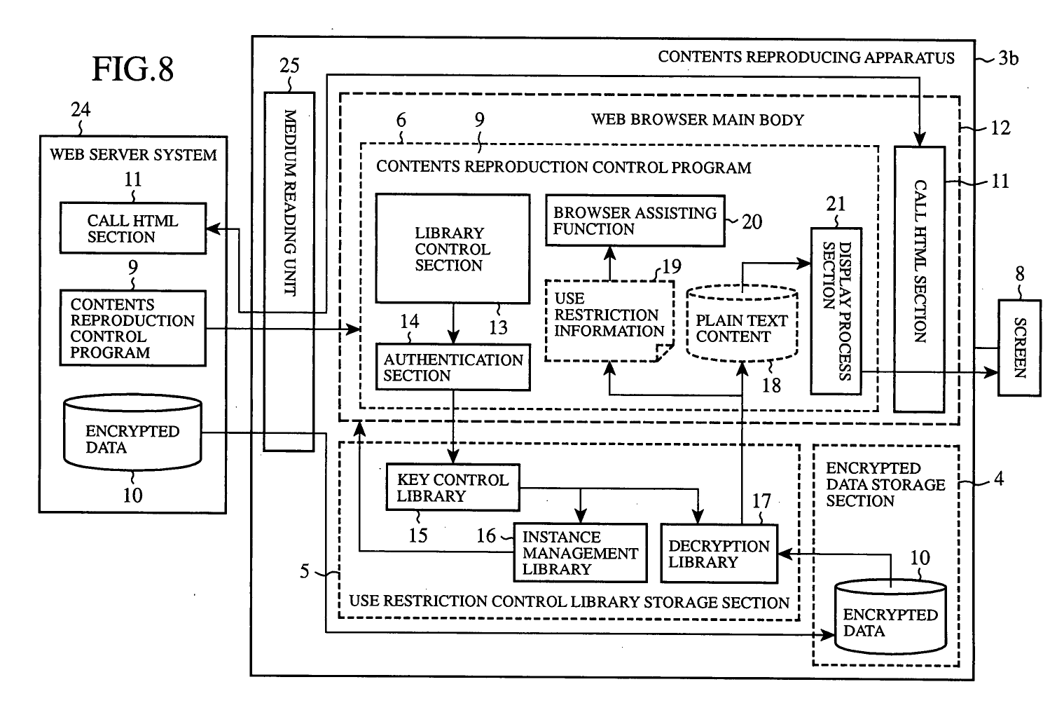

The second embodiment of the invention will be described below with reference to FIGS. 7 and 8. FIG. 7 is a schematic diagram of the system configuration that realizes a contents reproducing method according to the second embodiment, and FIG. 8 is a functional block diagram illustrating the specific structures of a contents reproducing apparatus or terminal unit 3b, etc. shown in FIG. 7. In FIGS. 7 and 8, reference numeral “24” denotes a recording medium, such as CD-ROM or DVD, and reference numeral “25” denotes a medium reading unit, such as a CD-ROM drive or a DVD-ROM drive. In the contents reproducing system according to the second embodiment, means for saving encrypted data 10 is the recording medium 24, such as CD-ROM or DVD, but not the server system 1 connected to the network 2.

Therefore, the terminal unit 3b must acquire the contents reproduction control program 9 and encrypted data 10 from the recording medium 24, so that the medium reading unit 25, such as a CD-ROM drive or a DVD-ROM drive, for reading saved data from the recording medium 24 into the terminal unit 3b is incorporated or attached externally. With like or same reference numerals given to those components of the second embodiment which are the same as the corresponding components of the first embodiment, their detailed description will be omitted. The terminal unit 3 in the second embodiment also displays a browser screen or the like as shown in FIG. 6.

In a case where a user decrypts encrypted data 10 and views Web contents, first, the Web browser 12 is activated and the call HTML section 11 generated on the browser screen makes a transfer request for the contents reproduction control program 9 in the second embodiment too. In the terminal unit 3b according to the second embodiment, however, the call HTML of the call HTML section 11 indicates the medium reading unit 25 in which the recording medium 24 is loaded. Accessing the call HTML section 11 issues a transfer request for the contents reproduction control program 9 saved in the recording medium 24 so that the contents reproduction control program 9 is stored in the contents reproduction control program storage section 6 in the terminal unit 3b via the medium reading unit 25. As the subsequent operation is almost identical to the operation of the first embodiment, its description will be omitted.

In the terminal unit 3b according to the second embodiment also, as apparent from the above, while the contents using function of the Web browser 12 which displays Web contents is inhibited by the contents reproduction control program 9, the browser assisting function 20 in place of the contents using function is generated to allow only a specific user to use the Web contents displayed on the browser screen. This can reliably prohibit illegitimate use of the Web contents by a third party. As the browser assisting function 20 is generated according to the use restriction information 19 that is registered for each user, each user is allowed to use only the browser assisting function 20 that is permitted by the use restriction information 19 that matches with the ID information of that user. This feature can prohibit illegitimate use of a user who is permitted to use Web contents and can surely prevent leakage of the Web contents displayed on the browser screen.

Further, the plain text content 18 and use restriction information 19, which have been restored through the decryption process performed by the decryption library 17 are both managed in the contents reproduction control program storage section 6, i.e., on the memory such as RAM provided in the terminal unit 3b. Therefore, those plain text content 18 and use restriction information 19 do not remain in the hard disk or cache in the terminal unit 3b. This makes it possible to surely prevent digital contents from being leaked by the manipulation of the Web browser 12.

What is claimed is:

1. A contents reproducing apparatus for acquiring encrypted data, reproducing image data from contents data restored from said encrypted data and displaying said image data on a browser screen of a browser, said apparatus comprising:
decryption means for decrypting said encrypted data;
memory means for temporarily storing the contents data restored by said decryption means and use restriction information of said restored contents data;
display process means for displaying the image data reproduced from said contents data stored in said memory means on said browser screen; and
contents reproduction control means for generating a browser assisting function in accordance with said use restriction information of said contents data, while inhibiting usage of a contents using function of said browser, and executing said contents using function inhibited by said browser assisting function.

2. The contents reproducing apparatus according to claim 1, further comprising use restriction control means which is activated by said contents reproduction control means and invalidates an operation signal input from input means in accordance with said use restriction information of said contents data.

3. The contents reproducing apparatus according to claim 1, further comprising an interface section to connect to a network so that said encrypted data is acquired from a server system connected to said network.

4. The contents reproducing apparatus according to claim 1, further comprising medium reading means for acquiring said encrypted data recorded in a recording medium.

5. A contents reproduction control program for allowing a computer, which acquires encrypted data stored in said saving means and displays image data reproduced from the contents data restored from said encrypted data on a browser screen of a browser, to achieve:
an inhibition process of inhibiting usage of a contents using function generated on said browser screen based on identification information input from an input means;
a storage process of temporarily storing contents data, restored by a decryption process of said encrypted data, and use restriction information of said restored contents data in a memory means; and
a browser assisting function process of generating a browser assisting function on said browser screen according to said use restriction information of said contents data, and executing said inhibited contents using function by using said browser assisting function.

6. The contents reproduction control program according to claim 5, wherein said identification information are composed of a user ID and a password.

7. The contents reproduction control program according to claim 5, wherein said use restriction information includes plural pieces of use restriction information registered user by user.

8. A contents reproduction control program for allowing a computer to achieve:
a process of acquiring encrypted data stored in saving means;
an authentication process of collating identification information input from an input means with prestored identification information to discriminate permission or inhibition of usage by a user who has input said identification information;
an inhibition process of inhibiting usage of a contents using function generated on a browser screen based on the result of the description performed in said authentication process;
a storage process of temporarily storing contents data, and use restriction information of said restored contents data, which are restored by a decryption process of said encrypted data in memory means;
a display process of reproducing image data from said contents data stored in said memory means and displaying said image data on said browser screen; and
a browser assisting function process of generating a browser assisting function according to said use restriction information of said contents data, and executing said inhibited contents using function by using said browser assisting function.

9. The contents reproduction control program according to claim 8, wherein said identification information are composed of a user ID and a password.

10. The contents reproduction control program according to claim 8, wherein said use restriction information includes plural pieces of use restriction information registered user by user.
